(19) United States
(12) Patent Application Publication
(10) Pub. No.: US 2010/0029350 A1
(43) Pub. Date: Feb. 4, 2010

(54) FULL-DUPLEX WIRELESS TRANSCEIVER DESIGN

(75) Inventor: Yang Zhang, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/184,318

(22) Filed: Aug. 1, 2008

(51) Int. Cl. H04M 1/00

(52) U.S. Cl. 455/575.7

(57) ABSTRACT

Techniques are provided for full-duplex mobile wireless transceiver design without using duplexers. In an embodiment, separate antennas are provided for the TX and RX signal paths in the transceiver. In an embodiment, the antennas may be implemented as surface mountable ceramic antennas. In an embodiment, the antennas may incorporate integrated band-pass filtering. Further techniques for designing the antennas to have different relative physical characteristics, including antenna orientation, are disclosed.

### TECHNICAL FIELD

The present disclosure relates to transceivers for wireless communications devices, and particularly, to mobile wireless transceivers featuring separate antennas for the transmit and receive signal paths.

### BACKGROUND

A full-duplex transceiver is a device that supports simultaneous signal transmission (TX) and reception (RX). In mobile devices, wireless full-duplex transceivers commonly feature separate TX and RX signal paths coupled to a single antenna via a duplexer. The duplexer allows both the TX and RX circuitry to share the same antenna to save space and cost, while isolating the TX and RX signals from each other. As the TX and RX signals typically occupy different frequency bands, the duplexer may incorporate the functions of band-pass filtering and frequency multiplexing.

Strict requirements are often imposed on duplexer design, e.g., for mobile phones designed to operate according to the code-division multiple-access (CDMA) cellular telephony standard. In such devices, duplexers are required to provide a great deal of isolation between TX and RX signals, whose frequencies may be relatively close to each other. Furthermore, such duplexers are required to introduce minimal insertion loss in the TX and RX signal paths. These competing requirements make duplexer design for mobile phones difficult as well as expensive.

It would be desirable to provide improved techniques for designing full-duplex mobile wireless transceivers.

### SUMMARY

An aspect of the present disclosure provides a transceiver apparatus for wireless communications comprising transmit (TX) circuitry for generating a TX signal to be wirelessly transmitted; a TX antenna coupled to said TX circuitry for transmitting said TX signal; an RX antenna for wirelessly receiving a receive (RX) signal; and receive (RX) circuitry for processing said RX signal.

Another aspect of the present disclosure provides a method for a mobile wireless communications device to simultaneously transmit and receive a signal, the method comprising: generating a transmit (TX) signal to be wirelessly transmitted; transmitting said TX signal over a TX antenna; wirelessly receiving a receive (RX) signal over an RX antenna; and processing said RX signal.

Yet another aspect of the present disclosure provides a transceiver apparatus for wireless communications comprising: transmit (TX) circuitry for generating a TX signal to be wirelessly transmitted; means coupled to said TX circuitry for wirelessly transmitting said TX signal; means for wirelessly receiving a receive (RX) signal; and receive (RX) circuitry for processing said RX signal.

### BRIEF DESCRIPTION OF DRAWINGS

FIG. 1 depicts a prior art implementation of a full-duplex wireless transceiver.

FIG. 2 illustrates an example of the characteristics of the duplexer 120.

FIG. 3 depicts an embodiment according to the present disclosure, wherein separate antennas are provided for the TX and RX signal paths.

FIG. 4 illustrates an example of the characteristics of the wireless transceiver 300 shown in FIG. 3.

FIG. 5 depicts an embodiment of a method according to the present disclosure.

### DETAILED DESCRIPTION

The present disclosure describes providing separate antennas for the TX and RX signal paths while minimizing cost and space in a mobile wireless device.

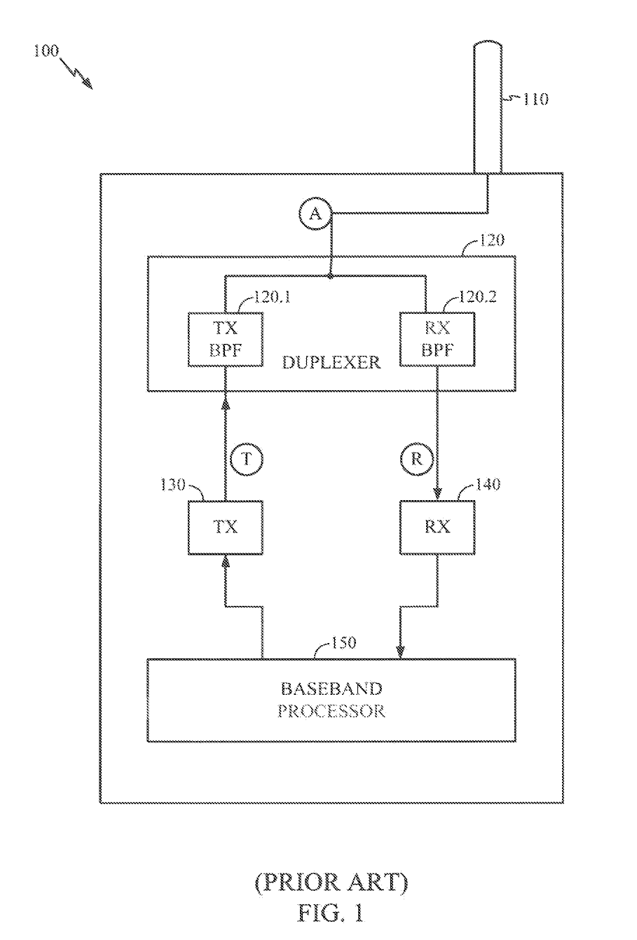

FIG. 1 depicts a prior art implementation of a full-duplex wireless transceiver. Note the prior art implementation is shown for illustration only, and is not meant to limit the application of the techniques of the present disclosure to any particular implementation of a wireless communications device. One of ordinary skill in the art will recognize that an actual implementation of a wireless device will include components not shown in FIG. 1.

In FIG. 1, a wireless transceiver 100 includes a baseband processor 150 coupled to TX circuitry 130 and RX circuitry 140. The TX circuitry 130 and RX circuitry 140 have nodes T and R, respectively, both coupled to a duplexer 120. The duplexer 120 is also coupled to an antenna 110 at node A. Note the duplexer 120 may include a TX band-pass filter (BPF) 120.1 to filter the signals from node T to node A, as well as an RX BPF 120.2 to filter the signals from node A to node R. In alternative implementations (not shown), the duplexer may be physically separate from one or both of the TX/RX BPF's.

The duplexer 120 multiplexes transmission of the TX signal with reception of the RX signal over a single antenna 110. To isolate the TX and RX signals from each other, the duplexer 120 commonly relies on the fact that the TX and RX signals lie in different frequency bands, and are thus separable by the BPF's 120.1 and 120.2. For example, in CDMA, the TX frequency band may be 824-849 MHz, while the RX frequency band may be 859-894 MHz.

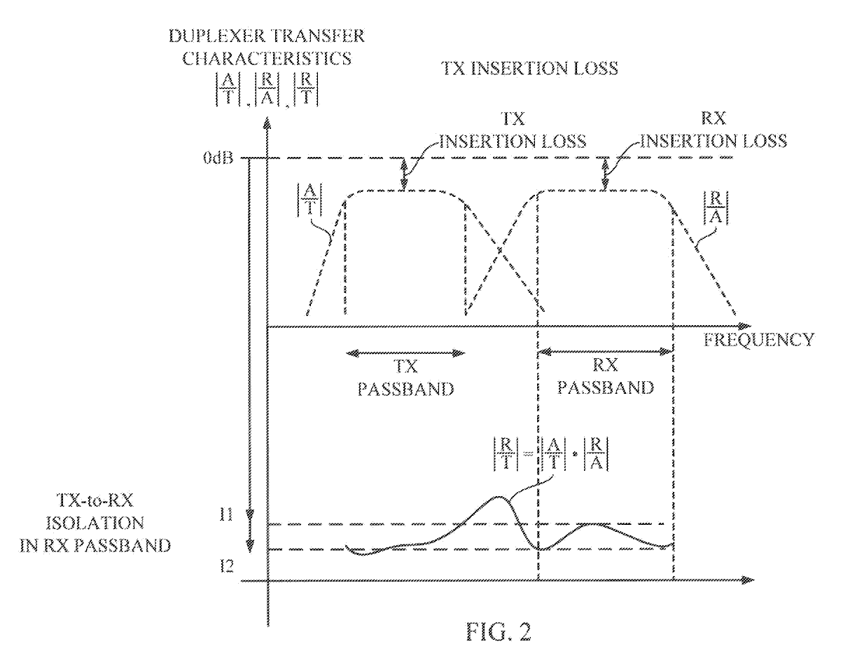

FIG. 2 illustrates an example of the characteristics of the duplexer 120. Note the characteristics shown in FIG. 2 are only meant to highlight the general features of a duplexer, and are not meant to limit the scope of the present disclosure to any particular characteristics shown.

In FIG. 2, duplexer transfer characteristics are plotted on the vertical axis, while frequency is plotted on the horizontal axis. Transfer characteristic

$$\vert \frac{A}{T} \vert$$

shows the signal magnitude at node A divided by the signal magnitude at node T. Note as a consequence of the BPF 120.1,

$$\vert \frac{A}{T} \vert$$

exhibits a bandpass characteristic with a passband denoted as the “TX passband.” The TX passband is further characterized by a “TX insertion loss” that represents the attenuation in the TX signal amplitude going from node T to node A at passband frequencies.

As further shown in FIG. 2, transfer characteristic

$$\vert \frac{R}{A} \vert$$

shows the signal magnitude at node R divided by the signal magnitude at node A over frequency. As a consequence of the BPF 120.2,

$$\vert \frac{R}{A} \vert$$

exhibits a bandpass characteristic with a passband denoted as the “RX passband.” The RX passband is further characterized by an “RX insertion loss” that represents the attenuation in the RX signal amplitude going from node A to node R at passband frequencies. Note both the TX and RX insertion losses may generally vary over their respective passbands.

Further shown in FIG. 2 is the transfer characteristic

$$\vert \frac{R}{T} \vert = \vert \frac{R}{A} \vert \vert \frac{A}{T} \vert , \vert \frac{R}{T} \vert$$

represents the RX signal magnitude at node R as a function of the TX signal magnitude at node T. The inverse of the magnitude of

$$\vert \frac{R}{T} \vert$$

in the RX passband is denoted as the “TX-to-RX isolation” in the RX passband, and represents the rejection of any signal leaking from the TX signal path at node T into the RX signal path at node R. In FIG. 2, the TX-to-RX isolation is shown as having values ranging between I1 and I2 over the RX passband.

In transceiver design, it is desired to maximize the TX-to-RX isolation, so that there is minimum interference from the strong TX signal to the relatively weak RX signal. It is also desired to minimize the TX and RX insertion losses, to avoid attenuation of the TX output signal and the RX signal received by the antenna over the air. In a transceiver for a wireless communications system such as CDMA or UMTS (Universal Mobile Telecommunications System), these competing design objectives may be difficult to meet as the TX and RX frequency bands may be relatively close in frequency, thus mandating extremely sharp roll-offs in the response of the BPF's.

According to the present disclosure, full-duplexer wireless transceiver design constraints are relaxed by providing separate antennas for each of the TX and RX signal paths.

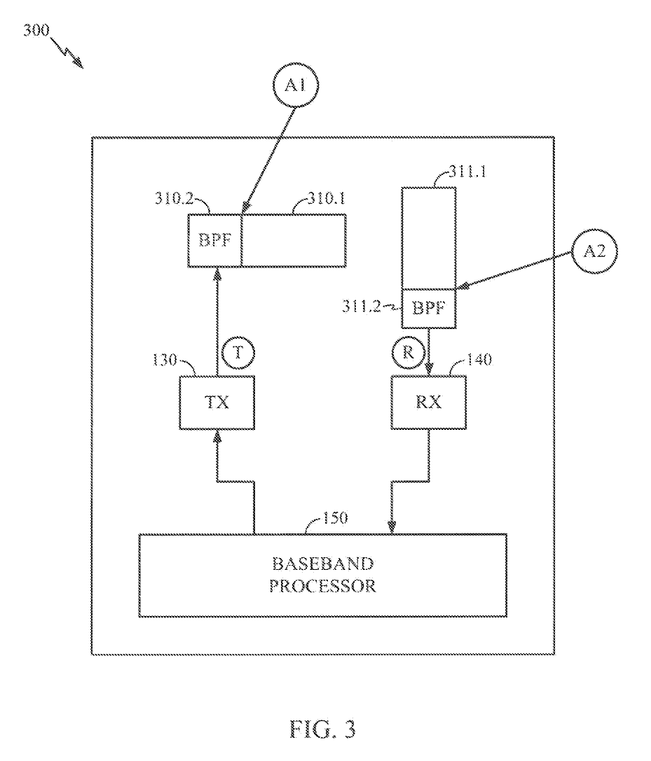

FIG. 3 depicts an embodiment according to the present disclosure, wherein separate antennas are provided for the TX and RX signal paths. In FIG. 3, antenna 310.1 is coupled to BPF 310.2 at node A1, and BPF 310.2 is in turn coupled to TX circuitry 130 at node T. BPF 310.2 is tuned to have a passband covering the TX frequency range. Similarly, antenna 311.1 is coupled to BPF 311.2 at node A2, and BPF 311.2 is in turn coupled to RX circuitry 140 at node R. BPF 311.2 is tuned to have a passband covering the RX frequency range.

In an embodiment, as described later herein, the separate antennas may be chosen to be of a type and physical construction that is lightweight and compact enough to be provided in a single mobile device.

Note the physical layout of the components in the transceiver of FIG. 3 is meant to be suggestive only, and is not meant to limit the scope of the disclosure to the specific layout shown. For example, greater or lesser physical separation than shown between the components may be present in an actual embodiment of the device.

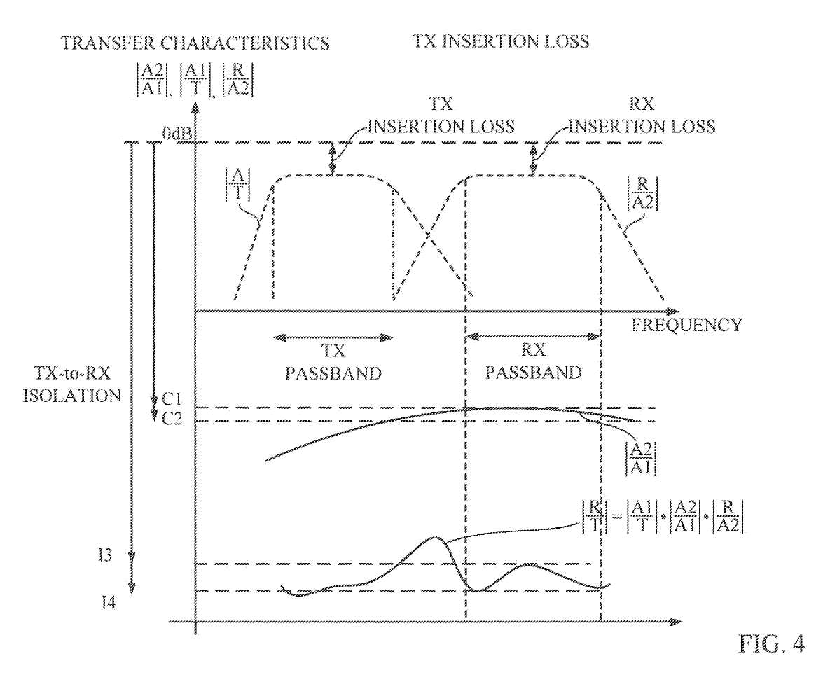

FIG. 4 illustrates an example of the characteristics of the wireless communications transceiver 300 shown in FIG. 3. Note the characteristics shown in FIG. 4 are only meant to highlight the features of the disclosed embodiment in general, and are not meant to limit the scope of the present disclosure to any particular characteristics shown.

In FIG. 4, transfer characteristics of the wireless transceiver 300 are plotted versus frequency.

$$\vert \frac{A 1}{T} \vert and \vert \frac{R}{A 2} \vert$$

characterize the response of bandpass filters 310.2 and 311.2, respectively.

$$\vert \frac{A 1}{T} \vert$$

has a passband denoted as the “TX passband,” while

$$\vert \frac{R}{A 2} \vert$$

has a passband denoted as the “RX passband.” The transfer characteristic

$$\vert \frac{A 2}{A 1} \vert$$

shows the signal magnitude at node A2 of RX antenna 311.1 divided by the signal magnitude at node A1 of TX antenna 310.1. These characteristics may be combined to derive the transfer characteristic

$$\vert \frac{R}{T} \vert = \vert \frac{A 1}{T} \vert \vert \frac{A 2}{A 1} \vert \vert \frac{R}{A 2} \vert ,$$

which is the inverse of the TX-to-RX isolation of the full-duplex transceiver shown in FIG. 3. In FIG. 4, the TX-to-RX isolation is shown as having values ranging between I3 and I4 over the RX passband.

Note from FIG. 4, it can be seen that the transfer characteristic

$$\vert \frac{R}{A} \vert$$

for the two-antenna transceiver of FIG. 3 incorporates a degree of freedom characterized by

$$\vert \frac{A 2}{A 1} \vert$$

that is not present in the corresponding transfer characteristic for the one-antenna duplexer-based transceiver of FIG. 1. The characteristic

$$\vert \frac{A 2}{A 1} \vert$$

may be understood as the antenna coupling between the TX antenna 310.1 and RX antenna 311.1. In FIG. 4,

$$\vert \frac{A 2}{A 1} \vert$$

is shown as having values ranging between C1 and C2 in the RX passband.

One of ordinary skill in the art will appreciate that since the antenna coupling

$$\vert \frac{A 2}{A 1} \vert$$

is generally less than 0 dB at any frequency in the RX passband, the transceiver shown in FIG. 3 generally provides greater TX-to-RX isolation than the duplexer-based transceiver shown in FIG. 1. To further maximize the TX-to-RX isolation of the system, the characteristic

$$\vert \frac{A 2}{A 1} \vert$$

may be minimized by design.

One of ordinary skill in the art will appreciate that antenna coupling between the TX and RX antennas may result from over-the-air reception by the RX antenna of a signal transmitted by the TX antenna. This antenna coupling may be reduced by increasing the spatial separation between the antennas, and/or designing the antennas to have different relative directional orientations and/or polarizations, and/or using any other technique known to one of ordinary skill in the art.

For example, in the embodiment depicted in FIG. 3, the TX antenna 310.1 is shown as having a longitudinal axis that is perpendicular to that of the RX antenna 311.1. The offset in the longitudinal axes of the antennas is expected to decrease their mutual coupling

$$\vert \frac{A 2}{A 1} \vert .$$

Other techniques such as increased physical separation may readily be incorporated in alternative embodiments of the present disclosure. Alternatively, the isolation between the antennas can be further improved by designing the antennas to have orthogonal polarizations.

In an embodiment, the antennas 310.1 and 311.1 depicted in FIG. 3 can be surface mountable dielectric antennas, such as those commercially available from Mitsubishi Materials, based in Tokyo, Japan (see, e.g., “Surface mountable dielectric chip antennas and series,” Mitsubishi Materials Part Numbers AMD0502-ST01 and AMD0302-ST01). The physical dimensions of such antennas are compact enough to allow a separate antenna to be provided for each of the TX and RX signal paths on a single substrate in a mobile wireless communications device, as depicted in FIG. 3. One of ordinary skill in the art will also appreciate that the ceramic antennas are surface mount technology (SMT) devices readily assembled in a single mobile wireless transceiver at low cost. The provision of separate antennas for the TX and RX eliminates the need for a duplexer, simplifying the design as well as lowering the cost of the mobile wireless transceiver 300.

Note the physical division between each BPF and antenna shown in FIG. 3 is for illustration only; alternative embodiments may provide for different physical shapes and configurations not shown for the BPF and antenna. For the example, the antenna and BPF need not lie in a rectangular configuration, and the size of the BPF versus the antenna may be different than shown in FIG. 3. Such alternative embodiments are contemplated to be within the scope of the present disclosure.

In an alternative embodiment, the TX antenna 310.1 may be a whip antenna, and the RX antenna 311.1 may be a ceramic antenna, and vice versa. In yet an alternative embodiment, either one of the antennas may be a patch antenna or a planar inverted-F (PIFA) antenna, known to one of ordinary skill in the art. In an embodiment, any combination of antennas of the types enumerated above may be employed. In an embodiment, the antenna type used for the TX antenna 310.1 may preferably be different from the antenna type used for the RX antenna 311.1. Such embodiments are contemplated to be within the scope of the present disclosure.

In alternative embodiments, the combination of antenna and BPF, i.e., antenna 310.1 and BPF 310.2, and/or antenna 311.1 and BPF 311.2, can be provided in a single physical package as a ceramic antenna incorporating an integrated band-pass filter.

As a further optimization, the dimensions of each antenna may be optimized to specifically accommodate the particular characteristics of the TX frequency band versus the RX frequency band. For example, the TX antenna and TX BPF may be designed to minimize the insertion loss introduced in the TX signal path by these components to maximize the TX transmit power of a mobile device, while the RX antenna and RX BPF may be designed to maximize the TX-to-RX isolation.

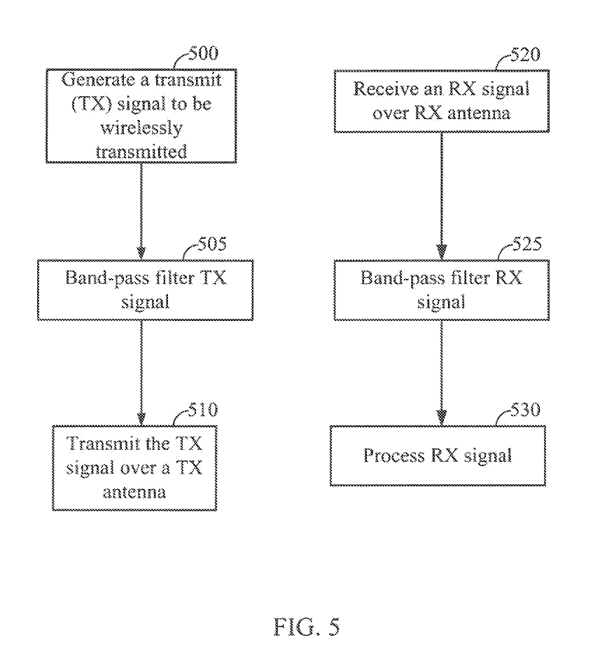

FIG. 5 depicts an embodiment of a method according to the present disclosure. In FIG. 5, at step 500, a TX signal is generated to be wirelessly transmitted. At step 505, the TX signal is band-pass filtered. At step 510, the TX signal is transmitted over a TX antenna.

At step 520, an RX signal is received over an RX antenna. At step 525, the RX signal is band-pass filtered. At step 530, the RX signal is further processed.

Note according to the present disclosure, steps 500-510 and steps 520-530 may be executed simultaneously for full-duplex operation.

Based on the teachings described herein, it should be apparent that an aspect disclosed herein may be implemented independently of any other aspects and that two or more of these aspects may be combined in various ways.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

A number of aspects and examples have been described. However, various modifications to these examples are possible, and the principles presented herein may be applied to other aspects as well. These and other aspects are within the scope of the following claims.

1. A transceiver apparatus for wireless communications comprising:
transmit (TX) circuitry for generating a TX signal to be wirelessly transmitted;
a TX antenna coupled to said TX circuitry for transmitting said TX signal;
an RX antenna for wirelessly receiving a receive (RX) signal; and
receive (RX) circuitry for processing said RX signal.

2. The apparatus of claim 1, the apparatus being a mobile wireless communications device.

3. The apparatus of claim 2, the mobile wireless communications device being a mobile phone.

4. The apparatus of claim 3, further comprising:
a TX band-pass filter (BPF) coupled between said TX antenna and said TX circuitry, said TX BPF having a passband tuned to a TX frequency band; and
an RX BPF coupled between said RX antenna and said RX circuitry, the RX BPF having a passband tuned to an RX frequency band.

5. The apparatus of claim 3, at least one of the TX and RX antennas comprising a ceramic antenna.

6. The apparatus of claim 5, both the TX and RX antennas comprising ceramic antennas.

7. The apparatus of claim 5, at least one of the TX and RX antenna comprising a whip antenna.

8. The apparatus of claim 3, at least one of the TX and RX antennas comprising a patch antenna.

9. The apparatus of claim 3, at least one of the TX and RX antennas comprising a planar inverted-F antenna.

10. The apparatus of claim 5, each of the ceramic antennas comprising an integrated band-pass filter (BPF), the BPF of the TX antenna having a passband tuned to a TX frequency band, the BPF of the RX antenna having a passband tuned to an RX frequency band.

11. The apparatus of claim 5, the TX antenna having a physical shape different from that of the RX antenna.

12. The apparatus of claim 5, the TX antenna having a longitudinal axis, the RX antenna also having a longitudinal axis, the longitudinal axis of the TX antenna being non-parallel to the longitudinal axis of the RX antenna.

13. The apparatus of claim 8, the longitudinal axis of the TX antenna being perpendicular to the longitudinal axis of the RX antenna.

14. The apparatus of the claim 5, the polarization of the TX antenna being orthogonal to the polarization of the RX antenna.

15. The apparatus of claim 5, the TX antenna having a physical size different from that of the RX antenna.

16. A method for a mobile wireless communications device to simultaneously transmit and receive a signal, the method comprising:
generating a transmit (TX) signal to be wirelessly transmitted;
transmitting said TX signal over a TX antenna;
wirelessly receiving a receive (RX) signal over an RX antenna; and
processing said RX signal.

17. The method of claim 16, the mobile wireless communications device being a mobile phone.

18. The method of claim 17, further comprising:
band-pass filtering the generated TX signal prior to transmitting over said TX antenna; and
band-pass filtering the RX signal received over the RX antenna before processing said RX signal.

19. The method of claim 17, at least one of the TX and RX antennas comprising a ceramic antenna.

20. The method of claim 19, both the TX and RX antennas comprising ceramic antennas.

21. The method of claim 19, at least one of the TX and RX antenna comprising a whip antenna.

22. The method of claim 19, at least one of the TX and RX antennas comprising a patch antenna.

23. The method of claim 19, at least one of the TX and RX antennas comprising a planar inverted-F antenna.

24. The method of claim 19, each of the ceramic antennas comprising an integrated band-pass filter (BPF), the BPF of the TX antenna having a passband tuned to a TX frequency band, the BPF of the RX antenna having a passband tuned to an RX frequency band.

25. The method of claim 19, the TX antenna having a physical shape different from that of the RX antenna.

26. The method of claim 19, the TX antenna having a longitudinal axis, the RX antenna also having a longitudinal axis, the longitudinal axis of the TX antenna being non-parallel to the longitudinal axis of the RX antenna.

27. The method of claim 26, the longitudinal axis of the TX antenna being perpendicular to the longitudinal axis of the RX antenna.

28. The method of claim 19, the polarization of the TX antenna being orthogonal to the polarization of the RX antenna.

29. The method of claim 19, the TX antenna having a physical size different from the physical size of the RX antenna.

30. A transceiver apparatus for wireless communications comprising:
transmit (TX) circuitry for generating a TX signal to be wirelessly transmitted;
means coupled to said TX circuitry for wirelessly transmitting said TX signal;
means for wirelessly receiving a receive (RX) signal; and
receive (RX) circuitry for processing said RX signal.

31. The transceiver apparatus of claim 30, the apparatus being a mobile wireless communications device.

32. The transceiver apparatus of claim 31, further comprising:
means for band-pass filtering the generated TX signal prior to transmitting over said TX antenna; and
means for band-pass filtering the wirelessly received RX signal prior to processing said RX signal.

33. The transceiver apparatus of claim 30, further comprising means for isolating the means for wirelessly transmitting said TX signal from the means for wirelessly receiving said RX signal.
